(19) United States
(12) Patent Application Publication
(10) Pub. No.: US 2005/0060263 A1
(43) Pub. Date: Mar. 17, 2005

(54) System and method for authentication

(76) Inventors: Lior Golan, Tel Aviv (IL); Amir Orad, Shoham (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/938,849

(22) Filed: Sep. 13, 2004

Related U.S. Application Data
(60) Provisional application No. 60/502,297, filed on Sep. 12, 2003.

(51) Int. Cl. G06F 17/60

(52) U.S. Cl. 705/44

(57) ABSTRACT

A device, system and method may aid in authenticating an applicant wishing to establish a relationship such as a bank account, credit card, or other relationship with an institution. Applicant information may be sent to a second institution, which may determine whether or not the applicant has a relationship (e.g. account) with the second institution; based on this determination the identity of the applicant may be authenticated.

### RELATED APPLICATION DATA

The present application claims benefit from prior provisional application Ser. No. 60/502,297 entitled “SYSTEM AND METHOD FOR AUTHENTICATION”, filed on Sep. 12, 2003, incorporated be reference herein in its entirety.

### FIELD OF THE INVENTION

The present invention relates to identity or other authentication; more specifically the present invention may be used, for example, in authenticating parties in a transaction.

### BACKGROUND

Stolen identities, stolen identification information, or fictitious identification information may be used in order to fraudulently establish and use relationships, such as to open financial accounts, gain access to them and withdraw funds from them, or otherwise make use of them. Such fraud may be performed by taking over an individual's identification details (such as name, date of birth or social security number, “SSN”), and posing as such individual, effectively “taking over its identity” (sometimes referred to as “identity theft”), or by creating a new identity (for example a newly invented identity, an identity based on a collection of stolen identification information of various individuals (sometimes referred to as “identity fraud”)).

The cost of such fraudulent activity is estimated at billions of dollars annually. The costs extend beyond financial losses to the loss of privacy and much inconvenience suffered by individual victims. Currently there are two main approaches to reducing identity fraud and theft, as well as to reducing their impact and costs. Some systems are intended to detect that fraud has actually taken place—these include primarily fraud detection systems, which aim to identify suspicious patterns of activity, and flag such activity. Such systems can be implemented internally by financial institutions, or resorted to as an external service by banks. The earlier the fraud is detected, the lesser are its costs. In addition, use is made of various types of databases to authenticate the identity of individuals seeking to open new financial accounts. These may include for example credit bureaus as well as other centralized databases.

Current systems have shortcomings. Fraud detection systems may respond only to a pattern, and therefore may not be able to identify single problematic transactions. Centralized databases may be susceptible to fraud once fraudsters gain access to certain data elements, and therefore cannot always differentiate between a true user and the fraudster. While credit bureaus have access to a wide variety of financial information, the access to that information may be open to fraudsters who pose as service providers who require access to the data. Moreover, sometimes the information collected by the credit bureaus is too complex to use as a basis for authentication, as honest individuals may not recall for example the size of installments they had previously paid on a loan. Other shortcomings exist. For example many existing solutions may require advance registration by those wishing to enter a transaction, and existing solutions may not be able to accommodate face to face encounters for validation.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 depicts an authentication system according to one embodiment of the present invention; and

FIG. 2 is a flowchart depicting a method according to an embodiment of the present invention.

It will be appreciated that for simplicity and clarity of illustration, elements shown in the figures have not necessarily been drawn to scale. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention. Various modifications to the described embodiments will be apparent to those with skill in the art, and the general principles defined herein may be applied to other embodiments. The present invention is not intended to be limited to the particular embodiments shown and described.

Embodiments of the current invention may enable providers (which may be referred to herein as for example institutions or Transaction Providers) of services or transactions that carry financial consequences, personal identity related consequences, or any other consequences to authenticate the identity of the individual or company which is attempting to access such service or perform such transaction (which may be referred to herein for example an applicant or Transaction Performer).

In one embodiment, institutions or Transaction Providers may find out whether there exist other institutions or Transaction providers who have a previous or preexisting relationship (which may be termed Qualifying Relationship, the institutions having such relationships possibly being termed “Previous Qualifying Providers”) with the applicant or Transaction Performer, and utilize Identifying Details, information or validation documents (such as for example, an ATM or debit card and a PIN, and their association with identification details such as a Social Security Number (“SSN’) or a combination of name and date of birth) associated with Previous Qualifying Providers in order to validate the identity of the applicant. The fact that a reputable entity has a working or ongoing relationship with an applicant may be evidence that the applicant is authentic and reputable.

A process according to some embodiments may allow an applicant to proceed with creating an account or other relationship at a first institution only if the second institution verifies that the applicant has a valid preexisting relationship with the second institution. This is not to say that the applicant is prevented from opening an account or establishing a relationship altogether—a process may allow or prevent an applicant from establishing a relationship via a certain path. An applicant may establish a relationship with an institution via another, more traditional, method. A process according to some embodiments may allow an applicant's identity to be validated based on a preexisting relationship with an institution; this identity may be used to permit an applicant to establish another relationship, but need not be.

Verification in some embodiments may only be performed if a preexisting relationship has certain characteristics. For example, the Transaction Provider or an intermediate party such as a verification service may determine whether or not a relationship is for example a Qualifying Relationship based on parameters such as the term of the relationship, the type and velocity of transactions performed as part of the relationship, and whether there has been established shared secrets as part of such relationship.

In one embodiment of the current invention the creation of a shared secret with a former transaction provider may be an element in determining whether such relationship qualifies, together with other qualifying elements, or without them. For example, a PIN number associated with a debit card, as well as other passwords, usernames and secret codes could serve to qualify such a relationship.

Embodiments of the invention may offer a higher degree of assurance as to an individual's identity, and may reduce the use of stolen identities, stolen identification information, or fictitious identification information in order to fraudulently open financial accounts, gain access to them and withdraw funds from them, or otherwise make use of them. Embodiments of the present invention may not require advance registration of institutions, and may accommodate face to face encounters as well as Internet, ATM or telephone based transactions. Different or additional benefits may be realized. In some embodiments a third party authentication service may be in contact with both an institution with which an applicant wishes to establish a relationship and a second, preexisting institution. The third party need not however contact the preexisting institution; the third party service may contact a different institution, use an internal database, etc. Further, in other embodiments, a third party authentication service separate from the institutions involved need not be used.

Given that in a many cases, individuals who wish to perform a transaction (such as for example open a new financial account, modify an existing one, apply for a credit card, apply for a loan) already have a pre-existing relationship with a different transaction provider, such individuals may also have a shared secret with such transaction provider. In one embodiment of the current invention such shared secret may be a PIN number associated with a an ATM card or a debit, or credit card, usually with a PIN associated with it.

According to one embodiment of the present invention, an association may be created between information related to an individual (e.g., Identifying Details, an ATM, debit or credit card possessed by an individual), and the PIN number associated with that card, for the purpose of validating an individual's identity.

According to another embodiment of the current invention, the validation process may require that the individual maintain or own the account with the Transaction provider, underlying the shared secret, more than a certain threshold period of time, and that a minimum number of transaction have been made utilizing such shared secret. In order to validate one's identity an individual may have to not only hold the physical card, but also the PIN as well as the SSN. The card and associated PIN used for the validation purposes typically does not belong to the same institution where a new account or relationship sought

The strength of such validation may be based on the fact that individuals' PINs are highly secure, and are usually not used for the purpose of authentication (other than in conjunction with a transaction performed with the associated card).

The linkage can be created in a variety of methods. An applicant (e.g., Transaction Performer) may be required to posses a card such as a debit/ATM card with an associated PIN for more than a certain threshold period in order to be authenticated using an embodiment of the present invention; such time limits need not be required. Individuals may be required or forced to utilize their “oldest” card (e.g., ATM card) and associated PIN for the sake of validation, rather than newer cards. Identification items other than bank or credit cards, PINs and social security numbers may be used.

For example, a user wishing to open a bank account with an institution that is a bank may be queried by the bank (via for example a third party service, or directly) for an existing bank, credit, or ATM card. It may be required that the card have been valid for a certain amount of time. The user may be queried for a password or PIN. The bank or third party service may check the card and password or PIN via for example the existing ATM network. The database of the institution that issued the previous card may be queried to verify that the applicant and card is valid, and that the card or account has existed for a certain amount of time.

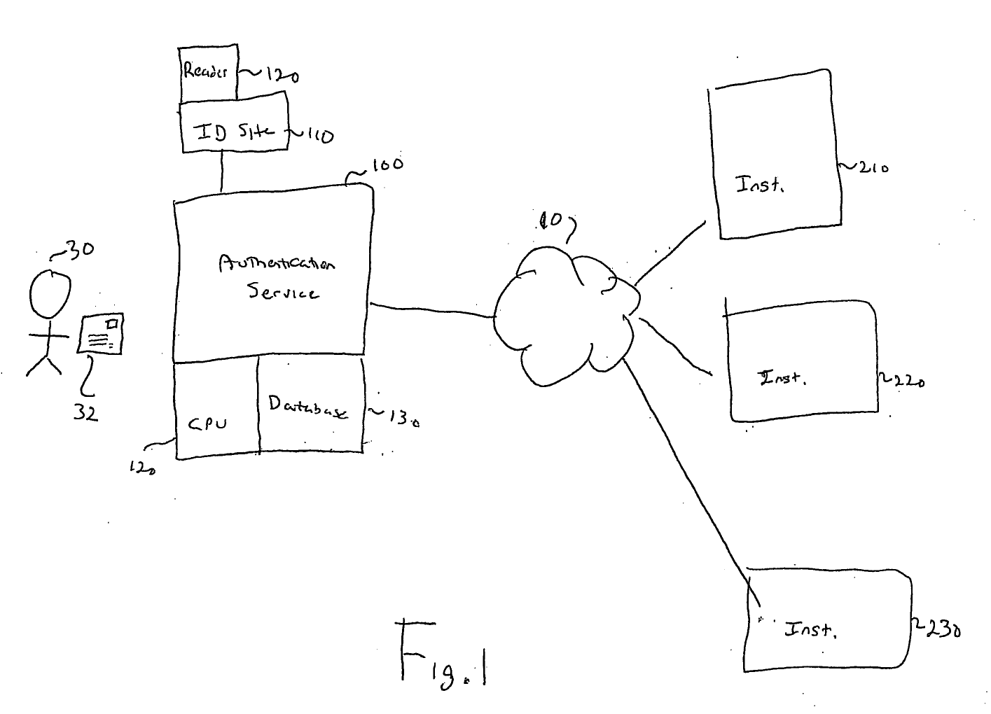

FIG. 1 depicts an authentication system according to one embodiment of the present invention. Referring to FIG. 1, an authentication service 100 may coordinate authentication or perform authentication among a number of institutions 210, 220 and 230. Authentication may be performed on behalf of an applicant 30. An applicant 30 may be an individual, a company, association, etc. Authentication service 100 may include or have access to, for example, an identification site 110 which may include, for example, a card reader 120. Alternately, card readers 120 may be associated with institutions 210, 220 and 230, and may transmit the relevant authentication data to the authentication service. The various components may be connected by one or more known communications systems 10, including for example, the Internet, telephone lines, data lines such as T1 lines, or other known communications systems using known protocols. An applicant 30 may have a physical identifier 32, such as an ATM or credit card, or another physically embodied form of identification or authentication. Authentication service 100 may include, for example, computing systems 120 (including suitable processors, controllers, etc.) and/or database systems 130. Database systems 130 may include one or more databases, and may be distributed among various different entities or sites. Database systems 130 may include, for example, information on institutions, such as member institutions and/or institutions that may be contacted to verify applicant data (the two sets of institutions may be the same), applicants or customers associated with or using an authentication service, specific information required by institutions to verify that an individual or applicant has a relationship or account with the institution, governance or policy information, additional criteria requirements, which institutions have relationships with applicants, preferred rank of use for querying institutions, length of time of relationship of institutions with the applicants, etc. Database systems 130 or other functionality may be distributed among institutions using or forming the authentication service.

Computing systems 120 may include suitable processors or controllers, and may be embodied in or include, for example, personal computer system(s), distributed systems, mainframes, etc. For example, computing systems 120 may include software operated on a personal computer which operates other software as well.

Institutions 210, 220 and 230 may be entities providing goods or services or financial transactions or other functions to applicant 30, and may function as for example providers or Transaction Providers. Applicant 30 (which may be referred to as a Transaction Performer) may wish to receive services or other functions from institutions 210, 220 and 230, such as for example opening a bank account, securing a loan or line of credit, obtaining a credit card, purchasing services, etc. Depending on the context, institutions 210, 220 and 230 may be, for example Transaction Providers or Previous Qualifying Providers.

While in one embodiment authentication service 100 is a third party relative to the institutions 210, 220 and 230 that use the authentication service 100, and is physically and organizationally separate or distinct from institutions 210, 220 and 230, in another embodiment one or more of institutions 210, 220 and 230 may act as or include the functionality of authentication service 100. For example, an institution among institutions 210, 220 and 230 may incorporate authentication service 100, or institutions 210, 220 and 230 may cooperate to perform the functions of authentication service 100.

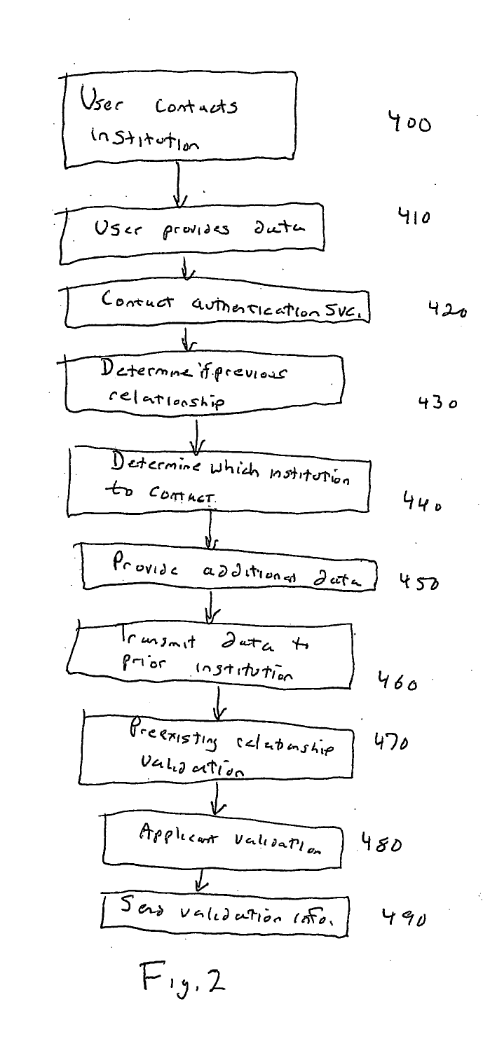

FIG. 2 is a flowchart depicting a method according to an embodiment of the present invention. While the embodiment of the invention as presented in FIG. 1 may be used to practice embodiments of a method of the invention, other systems and equipment may be used.

Referring to FIG. 2, in step 400, an applicant contacts a first institution to establish a relationship, for example to perform a transaction. For, example an individual wishes to be issued a new credit card. Other transactions are possible; for example, the purchase or sale of goods or services, obtaining a loan or credit, etc. Typically, the applicant has no prior relationship with the institution, and the institution wishes to verify the authenticity of the applicant's identity, and in addition possibly other information, such as the credit worthiness or other information relating to the applicant.

In step 410, the applicant may provide the institution with an identifying detail or other item or item(s) of information, such as for example a name and/or social security number. In one embodiment the initial information provided by the applicant is not as secret as later information—e.g., a name or social security number may be initially provided, and later (e.g., in step 450), an account number or PIN may be provided. Other information may be needed or used in step 410 or in step 450, for example, a bank account number, password, signature, an answer to a standard authorization question, a CVV or CVV2, the number of a bank or credit card, etc.

In step 420, the institution may contact the authentication service, transmitting to the service information it has collected from the applicant, such as identifying information, name, social security number, or other information. The information may not be transmitted. In addition, the information can be verified or checked directly with another institution. In other embodiments, the authentication service or parts of the functionality of the authentication service may be integrated with one or more institutions. For example, one or more of steps 430-460 may be performed by institutions, for example communicating among themselves, possibly maintaining internal databases, etc. Interaction between the applicant and authentication service or institution may be, for example, face to face or point of service, or possibly remotely, via for example, the Internet.

More than one interaction may be required—for example, after an initial contact with an institution with which the applicant wishes to establish a relationship, the applicant may be directed to contact an authentication service. The interaction with the authentication service may be at a secure location, such as via a card reader maintained by an institution associated with the authentication service or the authentication service. In one embodiment, the interface between the applicant and the authentication service may be via institutions associated with or in communication with the authentication service. For example, an applicant wishing to establish a relationship with institution 200 may interface with institution 200, exchanging data with card readers and personnel at institution 200, and institution 200 may transfer information to a separate authentication service to authenticate the applicant.

In step 430, the authentication service, after accepting information on the applicant and possibly other information, may determine if a second institution (e.g., a Previous Qualifying Provider) has engaged in a previous transaction with or maintains an existing or past relationship (e.g., a Qualifying Relationship) with the applicant. For example, the authentication service may determine if the applicant maintains a bank account with, has a loan outstanding with, has purchased goods or services from, another institution.

Typically, the institutions for which the authentication service may determine such information are limited to a set of institutions participating in the service provided by the authentication service. For example, a group of institutions may form such a service or may join with or associate themselves with such a service. It may be possible that a set of institutions—e.g., one or more banks—may decide not to use or provide information to the authentication service.

The authentication service (or, e.g., an institution, if such functionality is performed by institutions) may determine which institutions have Qualifying Relationships, or previous or existing relationships with an applicant by referencing a database, for example database systems 130, or another database. In another embodiment, the authentication service may determine such information by querying institutions directly, or in some embodiments by querying the applicant for a list of possible institutions to contact.

In step 440, the authentication service may determine which among a set of institutions determined to be Previous Qualifying Providers to contact (wherein set may include one). This may involve, for example, ranking the institutions by certain criteria, such as length of time of relationship with the applicant, “strength” of relationship (e.g., amount of money in transactions), etc. Such a determination need not be made—for example, the first on a list of institutions maybe contacted.

In step 450, the authentication service may request of the applicant to provide additional data and/or present physical items, to authenticate the relationship with the relevant institution, such as the Previous Qualifying Provider or the institution chosen in step 440. Data may be, e.g., a PIN, a password, an account number, a recent transaction number, or an attributed secret associated with the applicant and the relevant institution. For example, if a bank is chosen as the relevant institution, the applicant may be requested to present the ATM card associated with the bank and in addition enter the PIN associated with the ATM card. Such presentation may be provided, for example, at card reader 120. Other data may be provided; for example, if a Previous Qualifying Provider is a mutual find company, an account number and possibly a PIN or recent transaction code may be provided. The authentication service may request that the applicant present himself or herself, to provide face to face interaction, or may accommodate such interaction if required by the nature of information requested (e.g., the presentation and use of an ATM card), or if the applicant wishes. Such face to face interaction may be provided, e.g., by the authentication service itself, by an institution (e.g., a bank) associated with the authentication service, etc.

Which authentication data (e.g., data and/or physical items) the applicant should present may be pre-set, or may differ and be based on the specific relevant institution. For example, if a database lookup is used, the database may include in the entry for the institution the set of authentication data required. In an alternative embodiment, the authentication data may query the relevant institution as to which data to request.

In one embodiment, when an institution wishes to validate an applicant's identity, the applicant may provide for example identifying details (e.g., a SSN), his or her ATM or other card, and a PIN. The PIN associated with the card, may be validated via existing infrastructure (such as ATM network, EMV infrastructure or other means). The prior institution (e.g., Previous Qualifying Provider) which issued the card may examine whether the SSN (or other identifying detail) is correct and whether this is a qualifying account. This can be carried out face-to-face (by utilizing a terminal connected to the ATM network or other infrastructure), via the Internet, the phone, or at an ATM machine or via other suitable methods.

In some embodiments, the applicant may be required to show not only that he or she has information as to the existence of the relationship with the relevant institution, but in addition attributed secret data, such as passwords or PINs, showing that the applicant is the actual person having the relationship. For example, a social security number, account number, or ATM card may be stolen, but it is less likely that a password, or a combination of data, is stolen. Secondary information, such as an application number provide by a bank, may be requested. Various other data items or combinations of data items may be required.

In step 460, the authentication service may transmit data regarding the applicant request to the relevant institution (e.g., the second institution), such as the Previous Qualifying Provider. Such transmission of information may be performed, for example, via communications systems 10. Transmitted information may include, for example, identification of the applicant and possibly additional data items on the applicants, such as an attributed secret data, a PIN, a password, an account number, etc.

In place of transmitting information to a second institution or an institution having some previous relationship with a user, the information (e.g., an identification, a password) may be checked against a database, for example a database kept at an authentication service, or with a third party.

In step 470, the relevant institution may determine if it has a preexisting relationship with the applicant, and/or whether or not the transmitted applicant data is valid, and in addition possibly whether or not the relationship between the institution and applicant are valid. The relevant institution may authenticate the identity of the applicant, for example based on a preexisting applicant relationship. The results (e.g., positive or negative, or more involved results) may be sent to the authentication service. While in some embodiments, the results may be used to permit an applicant to establish another relationship, in other embodiments this need not happen. Further, a determination of “positive” or “negative” or other results may take place at an authentication service.

Various combinations of information may be validated. For example, the institution may validate that the account number or ATM card number provided is a qualifying number and belongs to an individual with such a social security number or PIN. An institution may deny that the applicant is valid because, for example, an account number and/or PIN are invalid, an institution may confirm that the applicant has a valid relationship with the institution, the institution may notify the authentication service that the applicant has or had a relationship with the institution, but that the applicant is not in good standing, etc.

In step 480, the applicant may be validated, depending on the determination in step 470. If the validation is positive, the applicant may establish a relationship with or be allowed to establish a relationship with the first institution. The validation may be conditional. For example, the relationship with the second institution validated in step 470 may need to exist for a certain period of time beyond the validation in order that the applicant maintain the relationship requested with the first institution in step 400. For example, if it is determined later that an ATM card or an identity used to establish the relationship with the second institution has been stolen, the relationship established with the first institution may be cancelled.

In step 490, the validation information may be transmitted to the first institution, with which a relationship or transaction is requested. Other operations or series of steps may be used, and the operations discussed above may be performed by entities other than those discussed. For example, a first and second institution may cooperate directly to authenticate an applicant based on a preexisting relationship between the applicant and the second institution.

In one embodiment, in order for the information held by an institution such as a Previous Qualifying Provider to qualify as validating the identity of an applicant (e.g., a Transaction Performer), it may need to meet certain criteria. For example, in order for a debit card and its associated PIN, issued by an institution, to qualify for validating the identity of an applicant, it may be required to have been issued for more than a certain threshold period of time, and to have performed a certain minimum number of transactions, etc. Such additional criteria need not be used. Such additional criteria may, for example, be specific to the institution seeking to establish the new relationship with the applicant, or possibly may be part of a governance or policy scheme associated with the authentication service. Such policies or additional criteria requirements may be stored for example at a database associated with the authentication service.

An institution (e.g., a new Transaction Provider) wishing to validate the identity of an applicant may inquire with a provider of an authentication system, or with the applicant in advance whether there exists a relationship with a previous institution (e.g., a Previous Qualifying Provider) and for example whether the previous institution had for example issued for an ATM card or other suitable physical item, and in addition which has existed for a minimum period of time and/or shows some minimum activity. If a previous institution exists the current institution may force or require the use of this method, asking for the relevant card, its PIN number and possibly other identifying details, such as a social security number.

In some embodiments, in order to achieve a higher level of security, following a positive validation of an applicant's identity, a check may be made after a redefine period whether this is indeed a qualifying account and that, for example the account has not been reported to be fraudulent or the security of the account has not been breached (e.g., the relevant ATM card has not been reported as stolen). If the later check determines the security has been breached or there is a fraud, the institution that had formed the relationship with the individual may be alerted.

During a transaction according to some embodiments of the invention, an applicant may be required to provide a new secret piece of data (e.g., secret question/answer pairs, a biometric such as a fingerprint, etc.). In subsequent applications, this new piece of data can be required, possibly in addition to other data (e.g., SSN, identifying details, PIN, etc. This may allow the process and the system to continuously grow in strength in terms of the force of the verification. Once an applicant's identity is verified via the system according to one embodiment, the applicant's future exposure to fraud may be reduced.

In one embodiment, the authentication service (or an entity performing such functions) may determine which among several possible preexisting relationships the user should use for authentication. For example, one of several bank cards or items of secret information held by a user may be required for authentication. This may increase security, as a fraudulent applicant may have for example stolen a bank card or information. In other embodiments, a user may choose.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method comprising:
accepting an identification of an applicant and a data item of an applicant;
transmitting the identification and the data item to a second institution; and
determining if the applicant has a preexisting relationship with the second institution.

2. The method of claim 1, wherein the data item is an attributed secret data item.

3. The method of claim 1, wherein the attributed secret data item is an account number.

4. The method of claim 1, wherein the first institution is a bank.

5. The method of claim 1, comprising, if the determination is positive, allowing the applicant to establish a relationship with a first institution.

6. The method of claim 1, comprising allowing the applicant to proceed with creating an account at a first institution only if the second institution verifies that the applicant has a valid preexisting relationship with the second institution.

7. The method of claim 1, wherein the attributed secret data item is a password.

8. The method of claim 1, wherein the relationship is a transaction.

9. The method of claim 1, wherein the relationship is an account.

10. The method of claim 1, comprising storing a list of second institutions that may be contacted to verify applicant data.

11. The method of claim 1, comprising determining which among a set of institutions may be contacted to verify applicant data.

12. The method of claim 1, comprising verifying the identity of the applicant based on the determination.

13. A system comprising:
a controller to:
accept an identification of an applicant and an additional data item of the applicant;
transmit the identification and the attributed secret data item to a second institution; and
determine if the applicant has a preexisting relationship with the second institution.

14. The system of claim 13, wherein the controller is to allow the applicant to proceed with creating an account at a first institution only if the second institution verifies that the applicant has a valid preexisting relationship with the second institution.

15. The system of claim 13, wherein the attributed secret data item is a password.

16. The system of claim 13, wherein the first institution is a bank.

17. The system of claim 13, wherein the relationship is a transaction.

18. The system of claim 13, comprising a list of second institutions that may be contacted to verify applicant data.

19. The system of claim 13, wherein the controller is physically separate from the first institution and the second institution.

20. A method comprising:
accepting an identification of an applicant and an attributed secret data item of an applicant; and
authenticating the identity of the applicant based on a preexisting applicant relationship with an institution.

21. The method of claim 1, wherein the attributed secret data item is an account number.

22. The method of claim 1, wherein the institution is a bank.

23. The method of claim 1, wherein the attributed secret data item is a password.

24. The method of claim 1, comprising determining which among a set of institutions may be contacted to verify applicant data.

25. A method comprising:
accepting an identification of an applicant;
determining if the applicant has a preexisting relationship with a second institution; and
based on the determination, validating the identification of the applicant for a first institution.

26. The method of claim 25, wherein the first institution is a bank.

27. The method of claim 25, comprising choosing one among a set of second institutions to use for a preexisting relationship determination.

28. The method of claim 25, comprising determining an item of secret information on which to query the applicant.

29. The method of claim 25, comprising, if the determination is positive, allowing the applicant to establish a relationship with the first institution.

30. The method of claim 25, comprising determining if the applicant has a valid preexisting relationship with a second institution.

31. The method of claim 25, wherein determining if the applicant has a preexisting relationship with a second institution includes at least contacting the second institution.
